(19) United States
(12) Patent Application Publication
(10) Pub. No.: US 2024/0365834 A1
(43) Pub. Date: Nov. 7, 2024

(54) DIETARY SUPPLEMENT COMPOSITIONS AND METHODS FOR THEIR USE IN POST-WORKOUT RECOVERY

(71) Applicant: Melaleuca, Inc., Idaho Falls, ID (US)

(72) Inventor: Jordan Joy, Idaho Falls, ID (US)

(21) Appl. No.: 18/654,463

(22) Filed: May 3, 2024

Related U.S. Application Data
(60) Provisional application No. 63/463,727, filed on May 3, 2023.

(51) Int. Cl. A23L 33/175; A23L 2/39; A23L 2/56; A23L 29/00; A23L 33/15; A23L 33/16

(52) U.S. Cl. CPC A23L 33/175; A23L 2/39; A23L 2/56; A23L 29/045; A23L 33/15; A23L 33/16

(57) ABSTRACT

This document provides dietary supplement compositions. For example, dietary supplement compositions containing leucine, isoleucine, valine, lysine, phenylalanine, threonine, histidine, methionine, tryptophan, and tart cherry are provided herein. Also provided herein are methods for using the compositions to enhance post-workout recovery.

### CROSS-REFERENCE TO RELATED APPLICATIONS

This application claims priority from U.S. Provisional Application Ser. No. 63/463,727, filed May 3, 2023. The disclosure of the prior application is considered part of (and is incorporated by reference in) the disclosure of this application.

### TECHNICAL FIELD

This document relates to the field of dietary supplements. For example, this document relates to dietary supplement compositions that can be used to promote recovery of physiological tissues that may be compromised or damaged in the engagement of physical activity or exercise in humans or other mammals.

### BACKGROUND

Many consumers in the fitness and wellness space desire improved tissue recovery after engaging in physical activity. Physiological tissue can undergo various changes such as muscle damage, inflammation, and oxidative stress. Adequate recovery can enhance athletic performance, prevent injuries, and promote overall well-being. Current recovery methods such as rest, hydration, and nutrient intake have limitations in terms of effectiveness and efficiency.

### SUMMARY

This document provides dietary supplement compositions that can be used for human or animal consumption. The dietary supplement compositions provided herein can improve recovery of physiological tissues that may be compromised or damaged in the engagement of physical activity or exercise. In general, the dietary supplement compositions described herein can improve recovery rate after exercise, increase muscle size, improve strength, reduce exercise-induced muscle soreness, and/or reduce body fat of subjects that consume compositions. For example, the dietary supplement compositions provided herein can enhance post-workout recovery by accelerating muscle repair and/or reducing inflammation. In general, the dietary supplement compositions provided herein include the amino acids leucine, isoleucine, valine, lysine, phenylalanine, threonine, histidine, methionine, and tryptophan, in combination with tart cherry.

In a first aspect, this document features a dietary supplement composition that can include, consist of, or consist essentially of (a) leucine, isoleucine, valine, lysine, phenylalanine, threonine, histidine, methionine, and tryptophan, and (b) tart cherry. In some cases, the leucine, isoleucine, valine, lysine, phenylalanine, threonine, histidine, methionine, and tryptophan can be present in a total amount of about 5 g to about 20 g per serving of the composition. The composition can include the tart cherry in an amount of about 250 mg to about 1000 mg per serving of the composition. The composition can include the leucine in an amount of about 1 wt % to about 40 wt % per serving of the composition. The composition can include the isoleucine in an amount of about 0.5 wt % to about 20 wt % per serving of the composition. The composition can include the valine in an amount of about 1 wt % to about 20 wt % per serving of the composition. The composition can include the lysine in an amount of about 1 wt % to about 20 wt % per serving of the composition. The composition can include the phenylalanine in an amount of about 1 wt % to about 20 wt % per serving of the composition. The composition can include the threonine in an amount of about 0.5 wt % to about 15 wt % per serving of the composition. The composition can include the histidine in an amount of about 0.5 wt % to about 15 wt % per serving of the composition. The composition can include the methionine in an amount of about 0.03 wt % to about 5 wt % per serving of the composition. The composition can include the tryptophan in an amount of about 0.02 wt % to about 5 wt % per serving of the composition.

In some cases, the composition can further comprise creatine monohydrate. The composition can include the creatine monohydrate in an amount of about 1000 mg to about 6000 mg. In some cases, the composition can further comprise one or more minerals. The one or more minerals can include calcium, sodium, potassium, magnesium, or a combination thereof. The one or more minerals can be present in an amount of about 5 mg to about 400 mg. The composition can include one or more flavor enhancers. The one or more flavor enhancers can include sodium citrate, citric acid, sucralose, stevia, an amino masker, malic acid, a fruit flavoring, a fruit flavor sweetener, or a combination thereof. The composition can include one or more vitamins. The one or more vitamins can include vitamin A. The composition can be in powdered form. The composition can be dissolved or suspended in liquid. In some cases, the composition can be in powdered form and can be dissolved or suspended in water.

In another aspect, this document features a method of improving post-workout recovery, The method can include, or consist essentially of, administering an effective amount of a composition described herein to a subject during or after exercise. The composition can be administered less than 4 hours after exercise, or less than 2 hours after exercise. The method can include, prior to administering the composition, combining the composition of with a volume of water. The volume of water can be about 10 fluid ounces to about 20 fluid ounces.

In another aspect, this document features a powdered dietary supplement composition contained in a bulk package, the bulk package containing a measuring scoop and the powdered dietary supplement composition, the measuring scoop being sized to scoop an amount of the powdered dietary supplement composition suitable for blending with a liquid to form a beverage, wherein the amount of the powdered dietary supplement composition is 15 g to 40 g and contains, consists of, or consists essentially of (a) tart cherry in an amount of about 0.1 wt % to about 50 wt %; (b) leucine in an amount of about 1 wt % to about 40 wt %; (c) isoleucine in an amount of about 0.5 wt % to about 20 wt %; (d) valine in an amount of about 1 wt % to about 20 wt %; (e) lysine in an amount of about 1 wt % to about 20 wt %; (f) phenylalanine in an amount of about 1 wt % to about 20 wt %; (g) threonine in an amount of about 0.5 wt % to about 15 wt %; (h) histidine in an amount of about 0.5 wt % to about 15 wt %; (i) methionine in an amount of about 0.03 wt % to about 5 wt %; and (j) tryptophan in an amount of about 0.02 wt % to about 5 wt %. The powdered dietary supplement composition can further contain creatine monohydrate. The powdered dietary supplement composition can contain one or more minerals.

As used herein, the term “about” when used to refer to weight % in a composition means±10% of the reported weight %. As used herein, the term “about” when used to refer to measured characteristics of the composition means±20% of the reported value.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more cases of the invention are set forth in the accompanying drawings and the description below. Other features, objects, and advantages of the invention will be apparent from the description and drawings, and from the claims.

### DETAILED DESCRIPTION

This document provides dietary supplement compositions that contain the amino acids leucine, isoleucine, valine, lysine, phenylalanine, threonine, histidine, methionine, and tryptophan, in combination with tart cherry. The combination of the tart cherry and the amino acids leucine, isoleucine, valine, lysine, phenylalanine, threonine, histidine, methionine, and tryptophan can provide complementary mechanisms to enhance recovery by, for example, improving muscle damage repair and/or reducing oxidative stress and its contribution to muscle damage. In some cases, the dietary supplement compositions can also include one or more additional ingredients, such as creatine (e.g., creatine monohydrate), one or more minerals, one or more flavor enhancers, one or more vitamins, and/or one or more excipients.

For example, a dietary supplement composition provided herein can include the amino acids leucine, isoleucine, valine, lysine, phenylalanine, threonine, histidine, methionine, and tryptophan, in combination with tart cherry, creatine monohydrate, and optionally, one or more minerals, one or more flavor enhancers, one or more vitamins, and/or one or more excipients. In some cases, a dietary supplement composition provided herein can include the amino acids leucine, isoleucine, valine, lysine, phenylalanine, threonine, histidine, methionine, and tryptophan, in combination with tart cherry, one or more minerals, and optionally, creatine monohydrate, one or more flavor enhancers, one or more vitamins, and/or one or more excipients. In some cases, a dietary supplement composition provided herein can contain can include the amino acids leucine, isoleucine, valine, lysine, phenylalanine, threonine, histidine, methionine, and tryptophan, in combination with tart cherry, creatine (e.g., creatine monohydrate), one or more minerals, and optionally, one or more flavor enhancers, one or more vitamins, and/or one or more excipients.

The amino acids leucine, isoleucine, valine, lysine, phenylalanine, threonine, histidine, methionine, and tryptophan are not synthesized by the body. Inclusion of these amino acids in the dietary supplement compositions provided herein can accelerate recovery of active physiological tissues that may be compromised or damaged in the engagement of physical activity or exercise. For example, without being bound by a particular mechanism, leucine can function as a signaling molecule that is capable of activating muscle protein synthesis. Muscle protein synthesis is the process by which to repair existing muscle tissue and build new muscle tissue, which can assist with recovering from exercise, reducing muscle soreness, restoration of muscle function (e.g., power and/or strength), and/or adding muscle mass. Leucine, along with isoleucine, valine, lysine, phenylalanine, threonine, histidine, methionine, and tryptophan, also can serve as a substrate to form muscle proteins. In addition, these amino acids can be converted into other proteogenic amino acids (e.g., alanine, arginine, asparagine, aspartic acid, cysteine, glutamine, glutamic acid, glycine, proline, serine, and tyrosine).

The dietary supplement compositions provided herein also can contain tart cherry. Tart cherry (Prunus cerasus, also called Montgomery cherry) is a fruit that is rich in polyphenols, including anthocyanins, and thus, has high antioxidant potential. Exercise can increase the amount of reactive oxygen and reactive nitrogen species (e.g., free radicals) in muscle tissue. Reactive oxygen and reactive nitrogen species can contribute to muscle damage, which can require a period of time (e.g., 1 day, 2 days, 3 days, 4 days, 5 days, or longer) for recovery before exercise can resume. Without being bound by a particular mechanism, tart cherry can quench free radicals, and in combination with the amino acids in the compositions provided herein, can provide synergistic improvements to recovery from muscle damaging exercise (e.g., running or weight lifting) while also reducing pain, inflammation, and/or oxidative stress. The enhanced recovery capacity can lead to faster return of muscle power generating ability and dissipation of exercise-induced muscle soreness. It is to be noted that other sources of natural anti-oxidants also can be included in the dietary supplement compositions provided herein, in addition to or as alternatives to tart cherry. Non-limiting examples of sources of natural anti-oxidants include green tea extract, resveratrol, grape seed and grape skin extracts (polyphenols), omega 3 (e.g., eicosapentaenoic acid), and ginseng.

In some cases, the dietary supplement compositions provided herein can include creatine (e.g., as creatine monohydrate). Creatine monohydrate is a tripeptide containing glycine, methionine, and arginine. Creatine is endogenously produced in the liver and kidneys at a rate of about 1 g per day and stored in the skeletal muscle and brain, where it is converted to creatine phosphate with the addition of one phosphagen molecule. Creatine phosphate can donate its phosphagen to adenosine diphosphate, adenosine monophosphate, or adenosine to re-phosphorylate the cellular energy currency into higher energy molecules, such as ATP. Without being bound by a particular mechanism, this can extend the duration of time that the body is capable of engaging in maximal effort exercise and/or can increase training volume, which over time can translate to increased strength, power, and muscle mass. In some cases, the uptake of creatine phosphate into muscles can be enhanced when the dietary supplement compositions described herein are consumed post-workout. Dietary supplement compositions can contain creatine in any appropriate form (e.g., creatine monohydrate, creatine anhydrous, creatine ethyl ester, creatine malate, creatine methyl ester, creatine citrate, creatine pyruvate, creatine α-amino butyrate, creatine α-ketoglutarate, sodium creatine phosphate, creatine taurinate, cratein proglutamate, creatine ketoisocaproate, creatine orotate, carnitine creatinate, creatine decanoate, creatine gluconate, or any combination thereof.

In some cases, the dietary supplement compositions provided herein can include one or more minerals. For example, the dietary supplement compositions can contain one or more of sodium, potassium, magnesium, and calcium, which can replace the minerals lost through sweat and other bodily processes accelerated by physical activity. The one or more minerals can be included in any appropriate form. For example, calcium can be included as calcium lactate pentahydrate, magnesium can be included as magnesium oligofructose, sodium can be included as sodium chloride, and potassium can be included as potassium chloride.

As described herein, the amino acids leucine, isoleucine, valine, lysine, phenylalanine, threonine, histidine, methionine, and tryptophan can have a synergistic effect when combined with tart cherry to accelerate recovery of active physiological tissues that may be compromised or damaged in the engagement of physical activity or exercise. For example, the amino acids leucine, isoleucine, valine, lysine, phenylalanine, threonine, histidine, methionine, and tryptophan in combination with tart cherry can have complementary mechanisms to enhance recovery. For example, the amino acids leucine, isoleucine, valine, lysine, phenylalanine, threonine, histidine, methionine, and tryptophan can enhance muscle damage repair, while tart cherry can reduce oxidative stress.

Any appropriate amount of the combination of leucine, isoleucine, valine, lysine, phenylalanine, threonine, histidine, methionine, and tryptophan can be included in the dietary supplement compositions provided herein. In some cases, for example, the dietary supplement compositions can include the combination of leucine, isoleucine, valine, lysine, phenylalanine, threonine, histidine, methionine, and tryptophan in a total amount of at least about 1 g. In some cases, the dietary supplement compositions can include the combination of leucine, isoleucine, valine, lysine, phenylalanine, threonine, histidine, methionine, and tryptophan in a total amount of about 1 g to about 50 g per serving (e.g., about 2 g to about 40 g, about 3 g to about 30 g, about 4 g to about 20 g, about 5 g to about 15 g, or about 6 g to about 10 g per serving).

The dietary supplement compositions provided herein can contain any appropriate amount of lysine. In some cases, for example, the dietary supplement compositions can include lysine in an amount of at least about 300 mg. In some cases, the dietary supplement compositions can include lysine in an amount of about 300 mg to about 10000 mg per serving. For example, lysine can be present in a composition in an amount of about 300 mg to about 10000 mg, about 1000 mg to about 8000 mg, about 1000 mg to about 6000 mg, about 2000 mg to about 5000 mg, about 2500 mg to about 4000 mg, or about 3000 mg to about 3500 mg per serving. In some cases, lysine can be present in the dietary supplement compositions in an amount of about 3100 mg per serving, about 3150 mg per serving, about 3200 mg per serving, or 3250 mg per serving.

In some cases, the dietary supplement compositions provided herein can contain at least about 1 wt % of lysine. In some cases, the dietary supplement compositions provided herein can contain at least about 1 wt % to about 80 wt % of lysine. For example, lysine can be present in a composition in an amount of about 1 wt % to about 60 wt %, about 5 wt % to about 50 wt %, about 1 wt % to about 50 wt %, about 2 wt % to about 40 wt %, about 3 wt % to about 30 wt %, about 3.5 wt % to about 20 wt %, about 5 wt % to about 15 wt %, or about 8 wt % to about 13 wt %. In some cases, lysine can be present in the dietary supplement compositions in an amount of about 12 wt %.

The dietary supplement compositions provided herein can contain any appropriate amount of leucine. In some cases, for example, the dietary supplement compositions can include leucine in an amount of at least about 300 mg per serving. In some cases, the dietary supplement compositions can include leucine in an amount of about 300 mg to about 10000 mg per serving. For example, leucine can be present in a composition in an amount of about 300 mg to about 10000 mg, about 1000 mg to about 8000 mg, about 1000 mg to about 6000 mg, about 2000 mg to about 5000 mg, about 2500 mg to about 4000 mg, or about 3000 mg to about 3500 mg per serving. In some cases, leucine can be present in the dietary supplement composition in an amount of about 3200 mg per serving. In some cases, each serving of the dietary supplement compositions provided herein can contain leucine in an amount of about 2700 mg per serving, about 2800 mg per serving, about 2900 mg per serving, about 3000 mg per serving, about 3100 mg per serving, about 3200 mg per serving, or about 3300 mg per serving.

In some cases, the dietary supplement compositions provided herein can contain at least about 1 wt % of leucine. In some cases, the dietary supplement compositions provided herein can contain at least about 1 wt % to about 80 wt % of leucine. For example, leucine can be present in a composition in an amount of about 0.1 wt % to about 60 wt %, about 5 wt % to about 80 wt %, about 1 wt % to about 50 wt %, about 2 wt % to about 40 wt %, about 3 wt % to about 30 wt %, about 3.5 wt % to about 20 wt %, about 5 wt % to about 15 wt %, or about 8 wt % to about 13 wt %. In some cases, leucine can be present in the dietary supplement compositions in an amount of about 12 wt %.

The dietary supplement compositions provided herein can contain any appropriate amount of valine. In some cases, for example, the dietary supplement compositions can include valine in an amount of at least about 200 mg per serving. In some cases, the dietary supplement compositions can include valine in an amount of about 200 mg to about 10000 mg per serving. For example, valine can be present in a composition in an amount of about 200 mg to about 5000 mg, about 200 mg to about 4000 mg, about 500 mg to about 3000 mg, about 1000 mg to about 2500 mg, about 1500 mg to about 2500 mg, or about 1750 mg to about 2250 mg per serving. In some cases, valine can be present in the dietary supplement compositions in an amount of about 1950 mg per serving, about 2000 mg per serving, about 2050 mg per serving, about 2100 mg per serving, or about 2150 mg per serving.

In some cases, the dietary supplement compositions provided herein can contain at least about 1 wt % of valine. In some cases, the dietary supplement compositions provided herein can contain at least about 1 wt % to about 80 wt % of valine. For example, valine can be present in a composition in an amount of about 1 wt % to about 60 wt %, about 0.5 wt % to about 50 wt %, about 1 wt % to about 50 wt %, about 2 wt % to about 40 wt %, about 3 wt % to about 30 wt %, about 3.5 wt % to about 20 wt %, about 4 wt % to about 10 wt %, or about 5.5 wt % to about 9 wt %. In some cases, valine can be present in the dietary supplement compositions in an amount of about 8 wt %.

The dietary supplement compositions provided herein can contain any appropriate amount of phenylalanine. In some cases, for example, the dietary supplement compositions can include phenylalanine in an amount of at least about 200 mg per serving. In some cases, the dietary supplement compositions can include phenylalanine in an amount of about 200 mg to about 5000 mg per serving. For example, phenylalanine can be present in a composition in an amount of about 200 mg to about 4000 mg, about 200 mg to about 3000 mg, about 500 mg to about 3000 mg, about 1000 mg to about 2500 mg, about 1500 mg to about 2500 mg, or about 1750 mg to about 2250 mg per serving. In some cases, phenylalanine can be present in the dietary supplement compositions in an amount of about 1800 mg per serving, about 1825 mg per serving, about 1850 mg per serving, about 1875 mg per serving, or about 1900 mg per serving.

In some cases, the dietary supplement compositions provided herein can contain at least about 1 wt % of phenylalanine. In some cases, the dietary supplement compositions provided herein can contain at least about 1 wt % to about 80 wt % of phenylalanine. For example, phenylalanine can be present in a composition in an amount of about 1 wt % to about 80 wt %, about 5 wt % to about 80 wt %, about 1 wt % to about 50 wt %, about 2 wt % to about 40 wt %, about 3 wt % to about 30 wt %, about 3.5 wt % to about 20 wt %, about 4 wt % to about 10 wt %, or about 5.5 wt % to about 9 wt %. In some cases, phenylalanine can be present in the dietary supplement compositions in an amount of about 7 wt %.

The dietary supplement compositions provided herein can contain any appropriate amount of isoleucine. In some cases, for example, the dietary supplement compositions can include isoleucine in an amount of at least about 200 mg per serving. In some cases, the dietary supplement compositions can include isoleucine in an amount of about 200 mg to about 5000 mg per serving. For example, isoleucine can be present in a composition in an amount of about 200 mg to about 5000 mg, about 200 mg to about 4000 mg, about 500 mg to about 3000 mg, about 1000 mg to about 2500 mg, about 1500 mg to about 2500 mg, or about 1500 mg to about 2000 mg per serving. In some cases, isoleucine can be present in the dietary supplement compositions in an amount of about 1600 mg per serving, about 1650 mg per serving, about 1700 mg per serving, about 1750 mg per serving, or about 1800 mg per serving.

In some cases, the dietary supplement compositions provided herein can contain at least about 0.5 wt % of isoleucine. In some cases, the dietary supplement compositions provided herein can contain at least about 0.5 wt % to about 80 wt % of isoleucine. For example, isoleucine can be present in a composition in an amount of about 0.5 wt % to about 80 wt %, about 0.5 wt % to about 50 wt %, about 1 wt % to about 50 wt %, about 2 wt % to about 40 wt %, about 3 wt % to about 30 wt %, about 3.5 wt % to about 20 wt %, about 4 wt % to about 10 wt %, or about 5.5 wt % to about 9 wt %. In some cases, isoleucine can be present in the dietary supplement compositions in an amount of about 6.4 wt %.

The dietary supplement compositions provided herein can contain any appropriate amount of threonine. In some cases, for example, the dietary supplement compositions can include threonine in an amount of at least about 150 mg per serving. In some cases, the dietary supplement compositions can include threonine in an amount of about 150 mg to about 5000 mg per serving. For example, threonine can be present in a composition in an amount of about 150 mg to about 5000 mg, about 200 mg to about 4000 mg, about 500 mg to about 3000 mg, about 1000 mg to about 2500 mg, about 1000 mg to about 2000 mg, or about 1250 mg to about 1750 mg per serving. In some cases, threonine can be present in the dietary supplement compositions in an amount of about 1360 mg per serving, about 1380 mg per serving, about 1400 mg per serving, about 1420 mg per serving, about 1420 mg per serving, or about 1440 mg per serving.

In some cases, the dietary supplement compositions provided herein can contain at least about 0.5 wt % of threonine. In some cases, the dietary supplement compositions provided herein can contain at least about 0.5 wt % to about 80 wt % of threonine. For example, threonine can be present in a composition in an amount of about 0.5 wt % to about 80 wt %, about 0.5 wt % to about 50 wt %, about 1 wt % to about 50 wt %, about 2 wt % to about 40 wt %, about 3 wt % to about 30 wt %, about 3.5 wt % to about 20 wt %, about 4 wt % to about 10 wt %, or about 4.5 wt % to about 8 wt %. In some cases, threonine can be present in the dietary supplement compositions in an amount of about 5 wt %.

The dietary supplement compositions provided herein can contain any appropriate amount of histidine. In some cases, for example, the dietary supplement compositions can include histidine in an amount of at least about 150 mg per serving. In some cases, the dietary supplement compositions can include histidine in an amount of about 150 mg to about 5000 mg per serving. For example, histidine can be present in a composition in an amount of about 150 mg to about 5000 mg, about 200 mg to about 4000 mg, about 500 mg to about 3000 mg, about 1000 mg to about 2500 mg, about 1000 mg to about 2000 mg, or about 1200 mg to about 1750 mg per serving. In some cases, histidine can be present in the dietary supplement compositions in an amount of about 1330 mg per serving, about 1350 mg per serving, about 1370 mg per serving, or about 1400 mg per serving.

In some cases, the dietary supplement compositions provided herein can contain at least about 0.5 wt % of histidine. In some cases, the dietary supplement compositions provided herein can contain at least about 0.5 wt % to about 80 wt % of histidine. For example, histidine can be present in a composition in an amount of about 0.5 wt % to about 80 wt %, about 0.5 wt % to about 50 wt %, about 1 wt % to about 50 wt %, about 2 wt % to about 40 wt %, about 3 wt % to about 30 wt %, about 3.5 wt % to about 20 wt %, about 4 wt % to about 10 wt %, or about 4.5 wt % to about 8 wt %. In some cases, histidine can be present in the dietary supplement compositions in an amount of about 5 wt %.

The dietary supplement compositions provided herein can contain any appropriate amount of methionine. In some cases, for example, the dietary supplement compositions can include methionine in an amount of at least about 1 mg per serving. In some cases, the dietary supplement compositions can include methionine in an amount of about 1 mg to about 500 mg per serving. For example, methionine can be present in a composition in an amount of about 1 mg to about 400 mg, about 10 mg to about 300 mg, about 50 mg to about 150 mg, or about 75 mg to about 100 mg per serving. In some cases, methionine can be present in the dietary supplement compositions in an amount of about 75 mg per serving, about 81 mg per serving, about 83 mg per serving, or about 85 mg per serving.

In some cases, the dietary supplement compositions provided herein can contain at least about 0.03 wt % of methionine. In some cases, the dietary supplement compositions provided herein can contain at least about 0.03 wt % to about 30 wt % of methionine. For example, methionine can be present in a composition in an amount of about 0.03 wt % to about 30 wt %, about 0.03 wt % to about 20 wt %, about 0.04 wt % to about 15 wt %, about 0.05 wt % to about 10 wt %, about 0.1 wt % to about 10 wt %, about 0.1 wt % to about 1 wt %, or about 0.2 wt % to about 1 wt. In some cases, methionine can be present in the dietary supplement compositions in an amount of about 0.3 wt %.

The dietary supplement compositions provided herein can contain any appropriate amount of tryptophan. In some cases, for example, the dietary supplement compositions can include tryptophan in an amount of at least about 1 mg per serving. In some cases, the dietary supplement compositions can include tryptophan in an amount of about 1 mg to about 500 mg per serving. For example, tryptophan can be present in a composition in an amount of about 1 mg to about 400 mg, about 10 mg to about 300 mg, about 15 mg to about 150 mg, or about 25 mg to about 75 mg per serving. In some cases, tryptophan can be present in the dietary supplement compositions in an amount of about 48 mg per serving, about 49 mg per serving, or about 50 mg per serving.

In some cases, the dietary supplement compositions provided herein can contain at least about 0.02 wt % of tryptophan. In some cases, the dietary supplement compositions provided herein can contain at least about 0.02 wt % to about 20 wt % of tryptophan. For example, tryptophan can be present in a composition in an amount of about 0.2 wt % to about 20 wt %, about 0.03 wt % to about 20 wt %, about 0.04 wt % to about 15 wt %, about 0.05 wt % to about 10 wt %, about 0.1 wt % to about 10 wt %, about 0.15 wt % to about 1 wt %, or about 0.15 wt % to about 0.25 wt %. In some cases, tryptophan can be present in the dietary supplement compositions in an amount of about 0.18 wt %.

The dietary supplement compositions provided herein can contain any appropriate amount of tart cherry. In some cases, for example, the dietary supplement compositions can include tart cherry in an amount of at least about 50 mg per serving. In some cases, the dietary supplement compositions can include tart cherry in an amount of about 50 mg to about 3000 mg per serving. For example, tart cherry can be present in a composition in an amount of about 150 mg to about 2500 mg, about 175 mg to about 2000 mg, about 200 mg to about 1500 mg, about 250 mg to about 1000 mg, about 300 mg to about 800 mg, or about 400 mg to about 550 mg per serving. In some cases, tart cherry can be present in the compositions in an amount of about 500 mg per serving, about 510 mg per serving, or about 520 mg per serving.

In some cases, the dietary supplement compositions provided herein can contain at least about 0.1 wt % of tart cherry. In some cases, the dietary supplement compositions provided herein can contain at least about 0.1 wt % to about 50 wt % of tart cherry. For example, tart cherry can be present in a composition in an amount of about 0.1 wt % to about 30 wt %, about 0.5 wt % to about 20 wt %, about 1 wt % to about 15 wt %, about 1 wt % to about 10 wt %, about 1 wt % to about 5 wt %, or about 1 wt % to about 3 wt %. In some cases, tart cherry can be present in the compositions in an amount of about 1.9 wt %.

In some cases, the dietary supplement compositions provided herein include creatine (e.g., creatine monohydrate). When creatine monohydrate is present in the dietary supplement compositions provided herein, the dietary supplement compositions can contain any appropriate amount of creatine monohydrate. In some cases, for example, the dietary supplement compositions can include creatine monohydrate in an amount of at least about 500 mg per serving. In some cases, the dietary supplement compositions can include creatine monohydrate in an amount of about 500 mg to about 30000 mg per serving. For example, creatine monohydrate can be present in a composition in an amount of about 550 mg to about 25000 mg, about 1000 mg to about 20000 mg, about 1000 mg to about 10000 mg, about 2000 mg to about 8000 mg, about 4000 mg to about 6000 mg, or about 4500 mg to about 5500 mg per serving. In some cases, creatine monohydrate can be present in the compositions in an amount of about 5000 mg per serving, about 5050 mg per serving, or about 5100 mg per serving.

In some cases, the dietary supplement compositions provided herein can contain at least about 1 wt % of creatine monohydrate. In some cases, the dietary supplement compositions provided herein can contain at least about 1 wt % to about 80 wt % of creatine monohydrate. For example, creatine monohydrate can be present in a composition in an amount of about 1 wt % to about 80 wt %, about 5 wt % to about 80 wt %, about 1 wt % to about 50 wt %, about 2 wt % to about 40 wt %, about 3 wt % to about 30 wt %, about 5 wt % to about 25 wt %, about 10 wt % to about 20 wt %, or about 15 wt % to about 20 wt %. In some cases, creatine monohydrate can be present in the compositions in an amount of about 18.5 wt %.

In some cases, the compositions provided herein include one or more minerals. In some cases, the dietary supplement compositions provided herein can include calcium. When calcium is present in the dietary supplement compositions provided herein, the dietary supplement compositions can contain any appropriate amount of calcium. In some cases, for example, the dietary supplement compositions can include calcium in an amount of at least about 1 mg per serving. In some cases, the dietary supplement compositions can include calcium in an amount of about 1 mg to about 1300 mg per serving. For example, calcium can be present in a composition in an amount of about 5 mg to about 1000 mg, about 25 mg to about 500 mg, about 50 mg to about 300 mg, about 75 mg to about 200 mg, about 100 mg to about 200 mg, or about 150 mg to about 200 mg per serving. In some cases, the calcium can be present in the compositions in an amount of about 5 mg to about 200 mg, about 40 mg to about 70 mg, or about 50 mg to about 60 mg (e.g., about 54 mg) per serving.

In some cases, the dietary supplement compositions provided herein include calcium. Calcium can be included in the compositions in any appropriate form. For example, dietary supplement compositions provided herein can contain calcium as part of a mineral amino acid polysaccharide complex (see, e.g., U.S. Pat. No. 8,273,393), calcium carbonate, calcium citrate, calcium lactate pentahydrate, or any combination thereof. When calcium is present in the dietary supplement compositions provided herein, the dietary supplement compositions can contain any appropriate amount of calcium. In some cases, for example, the dietary supplement compositions can include calcium in an amount of at least about 0.1 mg per serving. In some cases, the dietary supplement compositions can include calcium in an amount of about 0.1 mg to about 500 mg. For example, calcium complete can be present in a composition in an amount of about 0.1 mg to about 500 mg per serving. For example, calcium complete can be present in a composition in an amount of about 0.1 mg to about 400 mg, about 10 mg to about 300 mg, about 15 mg to about 150 mg, or about 25 mg to about 75 mg per serving. In some cases, calcium complete can be present in the compositions in an amount of about 5 mg per serving, about 20 mg per serving, about 40 mg per serving, or about 60 mg per serving.

In some cases, the dietary supplement compositions provided herein can contain at least about 0.01 wt % of calcium complete. In some cases, the dietary supplement compositions provided herein can contain at least about 0.01 wt % to about 50 wt % of calcium complete. For example, calcium complete can be present in a composition in an amount of about 0.02 wt % to about 30 wt %, about 0.03 wt % to about 20 wt %, about 0.04 wt % to about 15 wt %, about 0.05 wt % to about 10 wt %, about 0.1 wt % to about 10 wt %, about 0.1 wt % to about 1 wt %, or about 0.3 wt % to about 1 wt. In some cases, calcium complete can be present in the compositions in an amount of about 0.23 wt %.

In some cases, the dietary supplement compositions provided herein include calcium lactate pentahydrate. When calcium lactate pentahydrate is present in the dietary supplement compositions provided herein, the dietary supplement compositions can contain any appropriate amount of calcium lactate pentahydrate. In some cases, for example, the dietary supplement compositions can include calcium lactate pentahydrate in an amount of at least at least about 5 mg per serving. In some cases, the dietary supplement compositions can include calcium lactate pentahydrate in an amount of about 5 mg to about 5000 mg per serving. For example, calcium lactate pentahydrate can be present in a composition in an amount of about 50 mg to about 4000 mg, about 100 mg to about 2000 mg, about 200 mg to about 1000 mg, about 250 mg to about 500 mg, about 300 mg to about 475 mg, or about 350 mg to about 450 mg per serving. In some cases, calcium lactate pentahydrate can be present in the compositions in an amount of about 50 mg per serving, about 100 mg per serving, about 150 mg per serving, about 200 mg per serving, about 300 mg per serving, or about 400 mg per serving.

In some cases, the dietary supplement compositions provided herein can contain at least about 0.1 wt % of calcium lactate pentahydrate. In some cases, the dietary supplement compositions provided herein can contain at least about 0.1 wt % to about 50 wt % of calcium lactate pentahydrate. For example, calcium lactate pentahydrate can be present in a composition in an amount of about 0.1 wt % to about 30 wt %, about 0.5 wt % to about 20 wt %, about 1 wt % to about 15 wt %, about 1 wt % to about 10 wt %, about 1 wt % to about 5 wt %, or about 1 wt % to about 3 wt %. In some cases, calcium lactate pentahydrate can be present in the compositions in an amount of about 1.44 wt %.

In some cases, the dietary supplement compositions provided herein can contain sodium. When sodium is present in the dietary supplement compositions provided herein, the dietary supplement compositions can contain any appropriate amount of sodium. In some cases, for example, the dietary supplement compositions can include sodium in an amount of at least about 50 mg per serving. In some cases, the dietary supplement compositions can include sodium in an amount of about 50 mg to about 800 mg per serving. For example, sodium can be present in a composition in an amount of about 75 mg to about 700 mg, about 100 mg to about 600 mg, about 150 mg to about 500 mg, about 200 mg to about 400 mg, about 300 mg to about 400 mg, or about 350 mg to about 375 mg per serving. In some cases, the sodium can be present in the compositions in an amount of about 100 mg to about 400 mg, about 300 to about 600 mg, or about 500 to about 700 mg per serving.

In some cases, the dietary supplement compositions provided herein can include sodium chloride. When sodium chloride is present in the dietary supplement compositions provided herein, the dietary supplement compositions can contain any appropriate amount of sodium chloride. In some cases, for example, the dietary supplement compositions can include sodium chloride in an amount of at least about 5 mg per serving. In some cases, the dietary supplement compositions can include sodium chloride in an amount of about 5 mg to about 5000 mg per serving. For example, sodium chloride can be present in a composition in an amount of about 50 mg to about 4000 mg, about 100 mg to about 2000 mg, about 300 mg to about 1000 mg, about 400 mg to about 600 mg, about 450 mg to about 575 mg, or about 475 mg to about 525 mg per serving. In some cases, sodium chloride can be present in the compositions in an amount of about 200 mg per serving, about 300 mg per serving, about 400 mg per serving, or about 500 mg per serving.

In some cases, the dietary supplement compositions provided herein can contain at least about 0.001 wt % of sodium chloride. In some cases, the dietary supplement compositions provided herein can contain at least about 0.1 wt % to about 50 wt % of sodium chloride. For example, sodium chloride can be present in a composition in an amount of about 0.1 wt % to about 30 wt %, about 0.5 wt % to about 20 wt %, about 1 wt % to about 15 wt %, about 1 wt % to about 10 wt %, about 1 wt % to about 5 wt %, or about 1 wt % to about 3 wt %. In some cases, sodium chloride can be present in the compositions in an amount of about 1.8 wt %.

In some cases, the dietary supplement compositions provided herein can include sodium citrate. When sodium citrate is present in the dietary supplement compositions provided herein, the dietary supplement compositions can contain any appropriate amount of sodium citrate. In some cases, for example, the dietary supplement compositions can include sodium citrate in an amount of at least about 5 mg per serving. In some cases, the dietary supplement compositions can include sodium chloride in an amount of about 5 mg to about 2500 mg per serving. For example, sodium citrate can be present in a composition in an amount of about 50 mg to about 2000 mg, about 50 mg to about 1500 mg, about 50 mg to about 1000 mg, about 100 mg to about 600 mg, about 100 mg to about 400 mg, or about 120 mg to about 140 mg per serving. In some cases, sodium citrate can be present in the compositions in an amount of about 30 mg per serving, about 50 mg per serving, about 80 mg per serving, or about 130 mg per serving.

In some cases, the dietary supplement compositions provided herein can contain at least about 0.01 wt % of sodium citrate. In some cases, the dietary supplement compositions provided herein can contain at least about 0.01 wt % to about 10 wt % of sodium citrate. For example, sodium citrate can be present in a composition in an amount of about 0.1 wt % to about 10 wt %, about 0.2 wt % to about 15 wt %, about 0.3 wt % to about 10 wt %, about 0.3 wt % to about 3 wt %, about 0.3 wt % to about 1 wt %, or about 0.4 wt % to about 0.6 wt %. In some cases, sodium citrate can be present in the compositions in an amount of about 0.48 wt %.

In some cases, the dietary supplement compositions provided herein can contain potassium. When potassium is present in the dietary supplement compositions provided herein, the dietary supplement compositions can contain any appropriate amount of potassium. In some cases, for example, the dietary supplement compositions can include potassium in an amount of at least about 20 mg per serving. In some cases, the dietary supplement compositions can include potassium in an amount of about 20 mg to about 500 mg per serving. For example, potassium can be present in a composition in an amount of about 25 mg to about 400 mg, about 75 mg to about 350 mg, about 100 mg to about 300 mg, about 150 mg to about 250 mg, or about 200 mg to about 225 mg per serving. In some cases, the potassium can be present in the compositions in an amount of about 50 mg to about 200 mg per serving.

In some cases, the dietary supplement compositions provided herein can include potassium chloride. When potassium chloride is present in the dietary supplement compositions provided herein, the dietary supplement compositions can contain any appropriate amount of potassium chloride. In some cases, for example, the dietary supplement compositions can include potassium chloride in an amount of at least about 5 mg per serving. In some cases, the dietary supplement compositions can include potassium chloride in an amount of about 5 mg to about 1000 mg per serving. For example, potassium chloride can be present in a composition in an amount of about 50 mg to about 750 mg, about 75 mg to about 650 mg, about 100 mg to about 500 mg, about 150 mg to about 400 mg, about 175 mg to about 300 mg, or about 200 mg to about 250 mg per serving. In some cases, potassium chloride can be present in the compositions in an amount of about 110 mg per serving, about 150 mg per serving, about 200 mg per serving, or about 225 mg per serving.

In some cases, the dietary supplement compositions provided herein can contain at least about 0.001 wt % of potassium chloride. In some cases, the dietary supplement compositions provided herein can contain at least about 0.01 wt % to about 50 wt % of potassium chloride. For example, potassium chloride can be present in a composition in an amount of about 0.02 wt % to about 30 wt %, about 0.03 wt % to about 20 wt %, about 0.04 wt % to about 15 wt %, about 0.05 wt % to about 10 wt %, about 0.1 wt % to about 10 wt %, about 0.1 wt % to about 1 wt %, or about 0.3 wt % to about 1 wt %. In some cases, potassium chloride can be present in the compositions in an amount of about 0.83 wt %.

In some cases, the dietary supplement compositions provided herein can contain magnesium. When magnesium is present in the dietary supplement compositions provided herein, the dietary supplement compositions can contain any appropriate amount of magnesium. In some cases, for example, the dietary supplement compositions can include magnesium in an amount of at least about 1 mg per serving. In some cases, the dietary supplement compositions can include magnesium in an amount of about 1 mg to about 450 mg per serving. For example, magnesium can be present in a composition in an amount of about 5 mg to about 450 mg, about 25 mg to about 400 mg, about 50 mg to about 300 mg, about 75 mg to about 200 mg, about 100 mg to about 200 mg, or about 150 mg to about 200 mg per serving. In some cases, the magnesium can be present in the compositions in an amount of about 5 mg to about 100 mg per serving.

In some cases, the dietary supplement compositions provided herein can include magnesium oligofructose (see, e.g., U.S. Pat. No. 8,273,393). When magnesium oligofructose is present in the dietary supplement compositions provided herein, the dietary supplement compositions can contain any appropriate amount of magnesium oligofructose. In some cases, for example, the dietary supplement compositions can include magnesium oligofructose in an amount of at least about 5 mg per serving. In some cases, the dietary supplement compositions can include magnesium oligofructose in an amount of about 5 mg to about 1000 mg per serving. For example, magnesium oligofructose can be present in a composition in an amount of about 50 mg to about 1000 mg, about 25 mg to about 600 mg, about 50 mg to about 400 mg, about 75 mg to about 300 mg, about 100 mg to about 200 mg, or about 125 mg to about 175 mg per serving. In some cases, magnesium oligofructose can be present in the compositions in an amount of about 15 mg per serving, about 30 mg per serving, about 50 mg per serving, about 100 mg per serving, or about 160 mg per serving.

In some cases, the dietary supplement compositions provided herein can contain at least about 0.01 wt % of magnesium oligofructose. In some cases, the dietary supplement compositions provided herein can contain at least about 0.01 wt % to about 50 wt % of magnesium oligofructose. For example, magnesium oligofructose can be present in a composition in an amount of about 0.02 wt % to about 30 wt %, about 0.03 wt % to about 20 wt %, about 0.04 wt % to about 15 wt %, about 0.05 wt % to about 10 wt %, about 0.1 wt % to about 10 wt %, about 0.1 wt % to about 1 wt %, or about 0.3 wt % to about 1 wt. In some cases, magnesium oligofructose can be present in the compositions in an amount of about 0.58 wt %.

In some cases, the dietary supplement compositions provided herein can include one or more flavor enhancers, sweeteners, and/or colorants. Non-limiting examples of flavor enhancers and sweeteners include sodium citrate, citric acid, potassium citrate, citrulline malate, sucralose, stevia, amino maskers, malic acid, bitterness maskers, acesulfame potassium, aspartame, monk fruit, sugar alcohols (e.g., erythritol, maltitol, and/or xylitol), rare sugars (e.g., allulose and/or tagatose), sugars such as dextrose, sucrose, fructose, glucose, maltose, or cane sugar, fruit flavor (e.g., peach mango flavor), and fruit flavors/fruit flavor sweeteners. In some cases, the dietary supplement compositions provided herein can include one or more vitamins (e.g., vitamin A and/or one or more B vitamins, which can serve as colorants). Other colorants that can be used include, without limitation, natural colors from fruits, spices, or vegetable powders or extracts, algae, vitamins, and/or minerals (e.g., beet, turmeric, paprika, astaxanthin, spirulina, riboflavin, and/or titanium dioxide). In some cases, the dietary supplement compositions provided herein can contain one or more mouthfeel modifiers.

When a dietary supplement composition contains one or more flavor enhancers or sweeteners, the one or more flavor enhancers or sweeteners can be present in any appropriate amount. For example, the dietary supplement compositions can include one or more flavor enhancers or sweeteners in an amount of at least at least about 5 mg per serving. In some cases, the dietary supplement compositions can include sucralose in an amount of about 5 mg to about 5000 mg per serving. For example, one or more flavor enhancers or sweeteners can be present in a composition in an amount of about 50 mg to about 5000 mg, about 500 mg to about 5000 mg, about 1000 mg to about 5000 mg, about 1500 mg to about 5000 mg, about 2000 mg to about 5000 mg, or about 2500 mg to about 5000 mg, about 3000 mg to about 5000 mg, about 3500 mg to about 5000 mg about 4000 mg to about 5000 mg, or about 4500 mg to about 5000 mg, per serving.

In some cases, the dietary supplement compositions provided herein can include citric acid. When citric acid is present in the dietary supplement compositions provided herein, the dietary supplement compositions can contain any appropriate amount of citric acid. In some cases, for example, the dietary supplement compositions can include citric acid in an amount of at least about 30 mg per serving. In some cases, the dietary supplement compositions can include citric acid in an amount of about 30 mg to about 10000 mg per serving. For example, citric acid can be present in a composition in an amount of about 50 mg to about 5000 mg, about 100 mg to about 4000 mg, about 500 mg to about 3000 mg, about 1000 mg to about 2500 mg, about 1500 mg to about 2500 mg, or about 1750 mg to about 2250 mg per serving. In some cases, citric acid can be present in the composition in an amount of about 2000 mg per serving.

In some cases, the dietary supplement compositions provided herein can contain at least about 0.1 wt % of citric acid. In some cases, the dietary supplement compositions provided herein can contain at least about 0.1 wt % to about 80 wt % of citric acid. For example, citric acid can be present in a composition in an amount of about 0.1 wt % to about 80 wt %, about 0.5 wt % to about 80 wt %, about 1 wt % to about 50 wt %, about 2 wt % to about 40 wt %, about 3 wt % to about 30 wt %, about 3.5 wt % to about 20 wt %, about 4 wt % to about 10 wt %, or about 5.5 wt % to about 9 wt %. In some cases, citric acid can be present in the composition in an amount of about 7.3 wt %.

In some cases, the dietary supplement compositions provided herein can include sucralose. When sucralose is present in the dietary supplement compositions provided herein, the dietary supplement compositions can contain any appropriate amount of sucralose. In some cases, for example, the dietary supplement compositions can include sucralose in an amount of at least at least about 5 mg per serving. In some cases, the dietary supplement compositions can include sucralose in an amount of about 5 mg to about 5000 mg per serving. For example, sucralose can be present in a composition in an amount of about 50 mg to about 4000 mg, about 100 mg to about 2000 mg, about 200 mg to about 1000 mg, about 250 mg to about 500 mg, about 300 mg to about 475 mg, or about 325 mg to about 450 mg per serving. In some cases, sucralose can be present in the composition in an amount of about 360 mg per serving.

In some cases, the dietary supplement compositions provided herein can contain at least about 0.01 wt % of sucralose. In some cases, the dietary supplement compositions provided herein can contain at least about 0.01 wt % to about 50 wt % of sucralose. For example, sucralose can be present in a composition in an amount of about 0.1 wt % to about 30 wt %, about 0.5 wt % to about 20 wt %, about 1 wt % to about 15 wt %, about 1 wt % to about 10 wt %, about 1 wt % to about 5 wt %, or about 1 wt % to about 3 wt %. In some cases, sucralose can be present in the composition in an amount of about 1.32 wt %.

In some cases, the dietary supplement compositions provided herein can include stevia. When stevia is present in the dietary supplement compositions provided herein, the dietary supplement compositions can contain any appropriate amount of stevia. In some cases, for example, the dietary supplement compositions can include stevia in an amount of at least about 0.1 mg per serving. In some cases, the dietary supplement compositions can include stevia in an amount of about 0.1 mg to about 500 mg per serving. For example, stevia can be present in a composition in an amount of about 0.1 mg to about 400 mg, about 10 mg to about 300 mg, about 50 mg to about 150 mg, or about 75 mg to about 125 mg per serving. In some cases, stevia can be present in the composition in an amount of about 100 mg per serving.

In some cases, the dietary supplement compositions provided herein can contain at least about 0.01 wt % of stevia. In some cases, the dietary supplement compositions provided herein can contain at least about 0.01 wt % to about 50 wt % of stevia. For example, stevia can be present in a composition in an amount of about 0.02 wt % to about 30 wt %, about 0.03 wt % to about 20 wt %, about 0.04 wt % to about 15 wt %, about 0.05 wt % to about 10 wt %, about 0.1 wt % to about 10 wt %, about 0.1 wt % to about 1 wt %, or about 0.3 wt % to about 0.5 wt %. In some cases, stevia can be present in the composition in an amount of about 0.37 wt %.

In some cases, the dietary supplement compositions provided herein can include an amino masker. When an amino masker is present in the dietary supplement compositions provided herein, the dietary supplement compositions can contain any appropriate amount of the amino masker. In some cases, for example, the dietary supplement compositions can include an amino masker in an amount of at least about 5 mg per serving. In some cases, the dietary supplement compositions can include the amino masker in an amount of about 5 mg to about 5000 mg per serving. For example, the amino masker can be present in a composition in an amount of about 50 mg to about 4000 mg, about 100 mg to about 2000 mg, about 300 mg to about 1000 mg, about 400 mg to about 600 mg, about 450 mg to about 575 mg, or about 475 mg to about 525 mg per serving. In some cases, the amino masker can be present in the composition in an amount of about 500 mg per serving.

In some cases, the dietary supplement compositions provided herein can contain at least about 0.01 wt % of an amino masker. In some cases, the dietary supplement compositions provided herein can contain at least about 0.01 wt % to about 50 wt % of the amino masker. For example, the amino masker can be present in a composition in an amount of about 0.1 wt % to about 30 wt %, about 0.5 wt % to about 20 wt %, about 1 wt % to about 15 wt %, about 1 wt % to about 10 wt %, about 1 wt % to about 5 wt %, or about 1 wt % to about 3 wt %. In some cases, the amino masker can be present in the composition in an amount of about 1.83 wt %.

In some cases, the dietary supplement compositions provided herein can include a mouthfeel modifier. When a mouthfeel modifier is present in the dietary supplement compositions provided herein, the dietary supplement compositions can contain any appropriate amount of the mouthfeel modifier. In some cases, for example, the dietary supplement compositions can include the mouthfeel modifier in an amount of at least at least about 5 mg per serving. In some cases, the dietary supplement compositions can include the mouthfeel modifier in an amount of about 5 mg to about 5000 mg per serving. For example, the mouthfeel modifier can be present in a composition in an amount of about 50 mg to about 4000 mg, about 100 mg to about 2000 mg, about 200 mg to about 1000 mg, about 250 mg to about 500 mg, about 300 mg to about 475 mg, or about 350 mg to about 450 mg per serving. In some cases, the mouthfeel modifier can be present in the composition in an amount of about 400 mg per serving.

In some cases, the dietary supplement compositions provided herein can contain at least about 0.01 wt % of the mouthfeel modifier. In some cases, the dietary supplement compositions provided herein can contain at least about 0.01 wt % to about 50 wt % of the mouthfeel modifier. For example, mouthfeel modifier can be present in a composition in an amount of about 0.1 wt % to about 30 wt %, about 0.5 wt % to about 20 wt %, about 1 wt % to about 15 wt %, about 1 wt % to about 10 wt %, about 1 wt % to about 5 wt %, or about 1 wt % to about 3 wt %. In some cases, the mouthfeel modifier can be present in the composition in an amount of about 1.46 wt %.

In some cases, the dietary supplement compositions provided herein can include malic acid. When malic acid is present in the dietary supplement compositions provided herein, the dietary supplement compositions can contain any appropriate amount of malic acid. In some cases, for example, the dietary supplement compositions can include malic acid in an amount of at least about 5 mg per serving. In some cases, the dietary supplement compositions can include malic acid in an amount of about 5 mg to about 5000 mg per serving. For example, malic acid can be present in a composition in an amount of about 50 mg to about 4000 mg, about 100 mg to about 2000 mg, about 300 mg to about 1000 mg, about 400 mg to about 600 mg, about 450 mg to about 575 mg, or about 475 mg to about 525 mg per serving. In some cases, malic acid can be present in the composition in an amount of about 500 mg per serving.

In some cases, the dietary supplement compositions provided herein can contain at least about 0.01 wt % of malic acid. In some cases, the dietary supplement compositions provided herein can contain at least about 0.01 wt % to about 50 wt % of malic acid. For example, malic acid can be present in a composition in an amount of about 0.1 wt % to about 30 wt %, about 0.5 wt % to about 20 wt %, about 1 wt % to about 15 wt %, about 1 wt % to about 10 wt %, about 1 wt % to about 5 wt %, or about 1 wt % to about 3 wt %. In some cases, malic acid can be present in the composition in an amount of about 1.83 wt %.

In some cases, the dietary supplement compositions provided herein can include a bitterness masker. When a bitterness masker is present in the dietary supplement compositions provided herein, the dietary supplement compositions can contain any appropriate amount of the bitterness masker. In some cases, for example, the dietary supplement compositions can include a bitterness masker in an amount of at least at least about 5 mg per serving. In some cases, the dietary supplement compositions can include a bitterness masker in an amount of about 5 mg to about 5000 mg per serving. For example, a bitterness masker can be present in a composition in an amount of about 50 mg to about 4000 mg, about 100 mg to about 2000 mg, about 200 mg to about 1000 mg, about 250 mg to about 500 mg, about 300 mg to about 475 mg, or about 350 mg to about 450 mg per serving. In some cases, a bitterness masker can be present in the composition in an amount of about 420 mg per serving.

In some cases, the dietary supplement compositions provided herein can contain at least about 0.01 wt % of QR81 nat bitter masking. In some cases, the dietary supplement compositions provided herein can contain at least about 0.01 wt % to about 50 wt % of QR81 nat bitter masking. For example, QR81 nat bitter masking can be present in a composition in an amount of about 0.1 wt % to about 30 wt %, about 0.5 wt % to about 20 wt %, about 1 wt % to about 15 wt %, about 1 wt % to about 10 wt %, about 1 wt % to about 5 wt %, or about 1 wt % to about 3 wt %. In some cases, QR81 nat bitter masking can be present in the composition in an amount of about 1.54 wt %.

In some cases, the dietary supplement compositions provided herein can include a fruit flavoring (e.g., a peach mango flavoring, a berry flavoring, a grape flavoring, or any other suitable fruit flavoring). When a fruit flavoring is present in the dietary supplement compositions provided herein, the dietary supplement compositions can contain any appropriate amount of the fruit flavoring. In some cases, for example, the dietary supplement compositions can include the fruit flavoring in an amount of at least about 5 mg per serving. In some cases, the dietary supplement compositions can include the fruit flavoring in an amount of about 5 mg to about 5000 mg per serving. For example, the fruit flavoring can be present in a composition in an amount of about 50 mg to about 4000 mg, about 100 mg to about 3000 mg, about 300 mg to about 2000 mg, about 400 mg to about 1750 mg, about 500 mg to about 1500 mg, or about 600 mg to about 1000 mg per serving. In some cases, the fruit flavoring can be present in the composition in an amount of about 800 mg per serving.

In some cases, the dietary supplement compositions provided herein can contain at least about 0.01 wt % of the fruit flavoring. In some cases, the dietary supplement compositions provided herein can contain at least about 0.01 wt % to about 50 wt % of the fruit flavoring. For example, the fruit flavoring can be present in a composition in an amount of about 0.1 wt % to about 30 wt %, about 0.5 wt % to about 20 wt %, about 1 wt % to about 15 wt %, about 1.5 wt % to about 10 wt %, about 1 wt % to about 5 wt %, or about 1.5 wt % to about 3 wt %. In some cases, the fruit flavoring can be present in the composition in an amount of about 2.93 wt %.

In some cases, the dietary supplement compositions provided herein can include a fruit flavor sweetener. When a fruit flavor sweetener is present in the dietary supplement compositions provided herein, the dietary supplement compositions can contain any appropriate amount of fruit flavor sweetener. In some cases, for example, the dietary supplement compositions can include the fruit flavor sweetener in an amount of at least about 0.1 mg per serving. In some cases, the dietary supplement compositions can include the fruit flavor sweetener in an amount of about 0.1 mg to about 500 mg per serving. For example, the fruit flavor sweetener can be present in a composition in an amount of about 0.1 mg to about 400 mg, about 10 mg to about 300 mg, about 50 mg to about 150 mg, or about 75 mg to about 125 mg per serving. In some cases, the fruit flavor sweetener can be present in the composition in an amount of about 100 mg per serving.

In some cases, the dietary supplement compositions provided herein can contain at least about 0.01 wt % of fruit flavor sweetener. In some cases, the dietary supplement compositions provided herein can contain at least about 0.01 wt % to about 50 wt % of fruit flavor sweetener. For example, the fruit flavor sweetener can be present in a composition in an amount of about 0.02 wt % to about 30 wt %, about 0.03 wt % to about 20 wt %, about 0.04 wt % to about 15 wt %, about 0.05 wt % to about 10 wt %, about 0.1 wt % to about 10 wt %, about 0.1 wt % to about 1 wt %, or about 0.3 wt % to about 1 wt %. In some cases, the fruit flavor sweetener can be present in the composition in an amount of about 0.37 wt %.

In some cases, the dietary supplement compositions provided herein can include a vitamin (e.g., vitamin A). When a vitamin is present in the dietary supplement compositions provided herein, the dietary supplement compositions can contain any appropriate amount of the vitamin. In some cases, for example, the dietary supplement compositions can include the vitamin in an amount of at least about 0.1 mg per serving. In some cases, the dietary supplement compositions can include the vitamin in an amount of about 0.1 mg to about 100 mg. For example, the vitamin can be present in a composition in an amount of about 0.1 mg to about 100 mg, about 0.1 mg to about 75 mg, about 1 mg to about 50 mg, about 2 mg to about 25 mg, or about 5 mg to about 15 mg per serving. In some cases, the vitamin can be present in the composition in an amount of about 10 mg per serving.

In some cases, the dietary supplement compositions provided herein can contain at least about 0.001 wt % of a vitamin (e.g., vitamin A). In some cases, the dietary supplement compositions provided herein can contain at least about 0.001 wt % to about 1 wt % of the vitamin. For example, the vitamin can be present in a composition in an amount of about 0.02 wt % to about 0.3 wt %, about 0.03 wt % to about 0.2 wt %, about 0.03 wt % to about 0.1 wt %, or about 0.03 wt % to about 0.05 wt %. In some cases, the vitamin can be present in the composition in an amount of about 0.04 wt %.

The dietary supplement compositions provided herein can be formulated in any appropriate manner. For example, the compositions provided herein can be in the form of a powder. In some cases, the compositions can be formulated as a liquid, solution, suspension, tablet, soft gelatin capsule, hard gelatin capsule, candy, sachet, gel, confectionary, shake, bar, or supplemented food.

In some cases, the dietary supplement compositions provided herein can be formulated for oral administration and can include one or more suitable excipients, flavorings, colorants, and other ingredients. Liquid preparations for oral administration can take the form of, for example, solutions, syrups, or suspension, or they can be presented as a dry product for constitution with water or other suitable liquid vehicle before use. In some cases, liquid preparations can include a dry powder in a solution or a suspension with a liquid. In some cases, liquid preparations can contain pharmaceutically acceptable additives such as suspending agents, emulsifying agents, non-aqueous vehicles, preservatives, buffer salts, flavoring agents, coloring agents, and/or sweetening agents. For oral administration, tablets or capsules can be prepared with pharmaceutically acceptable excipients such as binding agents, fillers, lubricants, disintegrants, or wetting agents. In some cases, tablets can include a coating (e.g., a polymer or polysaccharide-based coating with or without plasticizers and/or pigments). In some cases, preparations for oral administration can be formulated to give controlled release of one or more compounds. In some cases, tablets or capsules can be coated with a methacrylic acid copolymer and/or sodium alginate for release beyond the stomach (e.g., in the intestine, colon, or both). In some cases, tablets or capsules can be coated with sodium alginate for extension of release and better absorption (e.g., via liposomal technology). Other examples of slow release coatings that can be used include, without limitation, stearic acid, carbomer copolymer, shellac, hypromellose, carboxymethylcellulose sodium, carrageenan, cellaburate, ethylcellulose, glyceryl monooleate, pregelatinized modified starch, glyceryl monostearate, guar gum, hydroxypropyl betadex, hydroxypropyl cellulose, polyethylene oxide, polyvinyl acetate dispersion, pregelatinized starch, xanthan gum, alginic acid, locust bean gum, hydrogenated vegetable oil, monoglycerides, diglycerides, and combinations thereof.

In some cases, the dietary supplement compositions provided herein can be formulated as powder. For example, a dietary supplement composition can be a powder that can be dissolved in a liquid (e.g., water) for oral consumption. In some cases, a serving can be at least 15 g of the dietary supplement composition in powder form. In some cases, a serving of the dietary supplement composition can be about 15 g to about 40 g, about 20 g to about 40 g, about 25 g to about 40 g, about 30 g to about 40 g, or about 35 g to about 40 g, in powder form. In some cases, a serving of the dietary supplement composition can be about 25 g to about 30 g in powder form. In some cases, a serving of the dietary supplement composition can be about 27 g in powder form.

In some cases, one serving of the dietary supplement composition in powder form can be dissolved into at least 8 fluid ounces of liquid (e.g., water or any other suitable beverage). In some cases, a serving of the dietary supplement composition in powder form can be dissolved in about 8 fluid ounces to about 24 fluid ounces of liquid, about 10 fluid ounces to about 20 fluid ounces of liquid, about 12 fluid ounces to about 20 fluid ounces of liquid, about 14 fluid ounces to about 20 fluid ounces of liquid, about 14 fluid ounces to about 18 fluid ounces of liquid, or about 15 fluid ounces to about 17 fluid ounces of liquid. In some cases, a serving of the dietary supplement composition in powder form can be dissolved in about 10 fluid ounces of liquid to about 20 fluid ounces of liquid. In some cases, a serving of the dietary supplement composition in powder form can be dissolved in about 16 fluid ounces of liquid.

In some cases, a container or package containing a dry powder dietary supplement composition provided herein can include a measuring scoop or spoon sized to measure out a single serving of a dry powder dietary supplement composition provided herein. For example, a package (e.g., a jar, pouch, or any other suitable container) can contain multiple servings of a dry powder dietary supplement composition provided herein, and can be provided to a subject in combination with a measuring spoon, a scoop, or any other device suitable for measuring out a single serving of a dry powder dietary supplement composition provided herein. In some cases, a single serving of a dry powder dietary supplement composition provided herein can be packaged in a single serving packet, pouch, or any other appropriate container from which the dry powder dietary supplement composition can be dispensed into a fluid (e.g., water or another beverage) before consumption. In some cases, a plurality of such single serving containers can be packaged together (e.g., in a box or a larger pouch).

In some cases, dietary supplement compositions provided herein can contain a pharmaceutically acceptable carrier for administration to a mammal, including, without limitation, sterile aqueous or non-aqueous solutions, suspensions, and emulsions. Examples of non-aqueous solvents include, without limitation, propylene glycol, polyethylene glycol, vegetable oils, and organic esters. Aqueous carriers include, without limitation, water, alcohol, saline, and buffered solutions. Pharmaceutically acceptable carriers also can include physiologically acceptable aqueous vehicles (e.g., physiological saline) or other carriers appropriate for oral administration.

In some cases, the dietary supplement compositions provided herein can be in the form of a capsule or tablet, by way of an example only, configured to have a unit dosage equal to the daily desired dosage for a particular mammal. For example, if a mammal is to be administered a dose of 100 mg of a particular agent, each tablet can include about 100 mg in weight of that agent. The compositions provided herein can be formulated for administration to any appropriate mammal. For example, the compositions provided herein can be for administration to humans or other mammals (e.g., dogs, cats, mice, rats, rabbits, cows, horses, pigs, or sheep). In some cases, a total daily dose may be prepared and administered in the form of one or more dosage units (e.g., a scoop of powder, two scoops of powder, three scoops of powder, one tablet or capsule, two tablets or capsules, three tablets or capsules, four tablets or capsules, five tablets or capsules, or six tablets or capsules). For instance, in some cases, an exemplary dietary supplement composition can be provided in powder form in suspension in water.

Also provided herein are methods for using the compositions described herein as dietary supplements. For example, the compositions described here herein can be used as post-workout supplements (e.g., such as, supplements that can be used after a workout (e.g., physical exercise or physical training).

In some cases, the composition administered to a subject (e.g., consumed by a subject such as a human) can contain leucine, isoleucine, valine, lysine, phenylalanine, threonine, histidine, methionine, tryptophan, and tart cherry, and optionally one or more additional ingredients such as one or more flavor enhancers, one or more vitamins, and/or one or more excipients. In some cases, the composition administered to a subject (e.g., consumed by a subject) can contain leucine, isoleucine, valine, lysine, phenylalanine, threonine, histidine, methionine, tryptophan, and tart cherry, where the subject exhibits improved recovery of physiological tissues after engaging in physical activity or exercise, as compared to a control subject that did not consume a composition as described herein. In some cases, the control subject can be the same subject before consumption of a composition provided herein.

In some cases, the composition administered to a subject (e.g., consumed by a subject) can contain leucine, isoleucine, valine, lysine, phenylalanine, threonine, histidine, methionine, tryptophan, tart cherry, and creatine (e.g., creatine monohydrate), and optionally one or more additional ingredients such as one or more flavor enhancers, one or more vitamins, and/or one or more excipients. In some cases, the composition administered to a subject (e.g., consumed by a subject) can contain leucine, isoleucine, valine, lysine, phenylalanine, threonine, histidine, methionine, tryptophan, tart cherry, and creatine (e.g., creatine monohydrate), where the subject exhibits improved recovery of physiological tissues after engaging in physical activity or exercise, as compared to a control subject not administered the composition as described herein. In some cases, the control subject can be the same subject before consumption of a composition provided herein.

In some cases, the composition administered to a subject (e.g., consumed by a subject) can contain leucine, isoleucine, valine, lysine, phenylalanine, threonine, histidine, methionine, tryptophan, tart cherry, and one or more minerals, and optionally one or more additional ingredients such one or more flavor enhancers, one or more vitamins, and/or one or more excipients. In some cases, the composition administered to a subject (e.g., consumed by a subject) can contain leucine, isoleucine, valine, lysine, phenylalanine, threonine, histidine, methionine, tryptophan, tart cherry, and one or more minerals, where the subject exhibits improved recovery of physiological tissues after engaging in physical activity or exercise, as compared to a control subject not administered the composition as described herein. In some cases, the control subject can be the same subject before consumption of a composition provided herein.

In some cases, the composition administered to a subject (e.g., consumed by a subject) can contain leucine, isoleucine, valine, lysine, phenylalanine, threonine, histidine, methionine, tryptophan, tart cherry, creatine (e.g., creatine monohydrate), and one or more minerals, and optionally one or more additional ingredients such one or more flavor enhancers, one or more vitamins, and/or one or more excipients. In some cases, the composition administered to a subject (e.g., consumed by a subject) can contain leucine, isoleucine, valine, lysine, phenylalanine, threonine, histidine, methionine, and tryptophan in combination with tart cherry, creatine (e.g., creatine monohydrate), and one or more minerals, where the subject exhibits improved recovery of physiological tissues after engaging in physical activity or exercise, as compared to a control subject not administered the composition as described herein. In some cases, the control subject can be the same subject before consumption of a composition provided herein.

In some cases, the composition can be administered to (e.g., consumed by) a subject during exercise. In some cases, the composition can be administered to (e.g., consumed by) a subject after exercise. For example, the composition can be consumed by a subject within about 5 hours after exercise. In some cases, a composition provided herein can be administered to (e.g., consumed by) a subject within about 4 hours after exercise, within about 3 hours after exercise, within about 2 hours after exercise, within about 1 hour after exercise, or immediately following exercise. In some cases, the composition can be administered to (e.g., consumed by) the subject during exercise.

The compositions provided herein can be administered to a subject (e.g., can be consumed by a subject) one time in a day. Alternatively, the compositions can be administered (e.g., consumed) more than one time (e.g., two times, three times, or four times) in one day. In some cases, the compositions can be administered (e.g., consumed) one or more times (e.g., two times, three times, four times, five times, six times, seven times, eight times, nine times, ten times, or more than ten times) in 2 days, 3 days, 4 days, 5 days, 6 days, 7 days, 1 week, 2 weeks, 3 weeks, 4 weeks, 1 month, 2 months, 3 months, 4 months, 5 months, 6 months, 7 months, 8 months, nine months, 10 months, 11 months, 1 year, or more.

In some cases, consumption of the compositions provided herein can be effective to reduce the symptoms of muscle soreness in a subject following exercise (e.g., a subject who consumed a composition provided herein after physical training). In some cases, the methods provided herein can be used to enhance recovery by improving muscle repair and enhancing an increase in muscle mass following exercise. In some cases, the methods provided herein can be used to reduce oxidative stress and its contribution to muscle damage following exercise.

An effective amount of a composition can be, for example, an amount that is effective to improve recovery of physiological tissues that were compromised or damaged in the engagement of physical activity or exercise by a subject to which the composition is administered. For example, improved recovery following exercise in a subject to which the composition is administered can be increased by at least 5% (e.g., at least 10%, at least 20%, at least 25%, at least 30%, at least 50%, or at least 75%) as compared to a control subject. The improved recovery after working out can be acute, such as after a single consumption or administration of the composition (e.g., consumption or administration of a single dose of the composition). Additionally, or in the alternative, the improved recovery after working out can be longitudinal (e.g., may last for one or more days, weeks, or months), such as after repeated consumption or administration of the composition.

Changes in post-workout recovery can be measured by one or more of the following methods: assessing a visual analogue scale of soreness (such as delayed onset muscle soreness) or pain (e.g., joint or muscle pain, recovery, feeling ready to exercise, and/or stiffness; muscle power output; muscle strength; range of motion (e.g., flexibility); or measuring one or more markers of muscle damage such as creatine kinase, lactate dehydrogenase, 3-methyl histidine, myoglobin, aldolase, troponin, and aspartate aminotransferase.

The compositions and methods provided herein will be further described in the following examples, which do not limit the scope of the disclosure.

### EXAMPLES

### Example 1—an Exemplary Dietary Supplement Composition

A dietary supplement was prepared with the composition shown in Table 1 below. The dietary supplement was prepared as a powder.

TABLE 1
Exemplary dietary supplement composition.

| Ingredient | Amount per serving | Units |
|---|---|---|
| Amino acids: leucine, isoleucine, | 5-20 | g |
| valine, lysine, phenylalanine, threonine, | | |
| histidine, methionine, and tryptophan | | |
| Tart Cherry | 250-1000 | mg |

TABLE 2
Exemplary amounts of amino acids used for the
dietary supplement composition of Table 1.

| Amino Acid | Amount per serving | Units |
|---|---|---|
| Leucine | 300-10,000 | mg |
| Isoleucine | 200-5,000 | mg |
| Valine | 200-10,000 | mg |
| Lysine | 300-10,000 | mg |
| Phenylalanine | 200-5000 | mg |
| Threonine | 150-5000 | mg |
| Histidine | 150-5000 | mg |
| Methionine | 1-500 | mg |
| Tryptophan | 1-500 | mg |

### Example 2—An Exemplary Dietary Supplement Composition

A dietary supplement is prepared with the composition shown in Table 3 below. The dietary supplement was prepared as a powder.

TABLE 3
Exemplary dietary supplement composition.

| Ingredient | Amount per serving | Units |
|---|---|---|
| Amino acids: leucine, isoleucine, valine, | 5-20 | g |
| lysine, phenylalanine, threonine, histidine, | | |
| methionine, and tryptophan | | |
| Tart Cherry | 250-1000 | mg |
| Creatine Monohydrate | 1000-6000 | mg |

TABLE 4
Exemplary amounts of amino acids used for the
dietary supplement composition of Table 3.

| Amino Acid | Amount per serving | Unit |
|---|---|---|
| Leucine | 300-10,000 | mg |
| Isoleucine | 200-5,000 | mg |
| Valine | 200-10,000 | mg |
| Lysine | 300-10,000 | mg |
| Phenylalanine | 200-5000 | mg |
| Threonine | 150-5000 | mg |
| Histidine | 150-5000 | mg |
| Methionine | 1-500 | mg |
| Tryptophan | 1-500 | mg |

### Example 3—An Exemplary Dietary Supplement Composition

A dietary supplement is prepared with the composition shown in Table 5 below. The dietary supplement was prepared as a powder.

TABLE 5
Exemplary dietary supplement composition.

| Ingredient | Amount per serving | Units |
|---|---|---|
| Amino acids: leucine, isoleucine, valine, | 5-20 | g |
| lysine, phenylalanine, threonine, histidine, | | |
| methionine, and tryptophan | | |
| Tart Cherry | 250-1000 | mg |
| Potassium | 50-200 | mg |
| Magnesium | 5-100 | mg |
| Calcium | 5-200 | mg |
| Sodium | 100-400 | mg |

TABLE 6
Exemplary amounts of amino acids used for the
dietary supplement composition of Table 5.

| Amino Acid | Amount per serving | Unit |
|---|---|---|
| Leucine | 300-10,000 | mg |
| Isoleucine | 200-5,000 | mg |
| Valine | 200-10,000 | mg |
| Lysine | 300-10,000 | mg |
| Phenylalanine | 200-5000 | mg |
| Threonine | 150-5000 | mg |
| Histidine | 150-5000 | mg |
| Methionine | 1-500 | mg |
| Tryptophan | 1-500 | mg |

### Example 4—An Exemplary Dietary Supplement Composition

A dietary supplement is prepared with the composition shown in Table 7 below. The dietary supplement was prepared as a powder.

TABLE 7
Exemplary dietary supplement composition.

| Ingredient | Amount per serving | Units |
|---|---|---|
| Amino acids: leucine, isoleucine, valine, | 5-20 | g |
| lysine, phenylalanine, threonine, histidine, | | |
| methionine, and tryptophan | | |
| Tart Cherry | 250-1000 | mg |
| Creatine Monohydrate | 1000-6000 | mg |
| Potassium | 50-200 | mg |
| Magnesium | 5-100 | mg |
| Calcium | 5-200 | mg |
| Sodium | 100-400 | mg |

TABLE 8
Exemplary amounts of amino acids used for the
dietary supplement composition of Table 7.

| Amino Acid | Amount per serving | Unit |
|---|---|---|
| Leucine | 300-10,000 | mg |
| Isoleucine | 200-5,000 | mg |
| Valine | 200-10,000 | mg |
| Lysine | 300-10,000 | mg |
| Phenylalanine | 200-5000 | mg |
| Threonine | 150-5000 | mg |
| Histidine | 150-5000 | mg |
| Methionine | 1-500 | mg |
| Tryptophan | 1-500 | mg |

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A composition comprising:
(a) leucine, isoleucine, valine, lysine, phenylalanine, threonine, histidine, methionine, and tryptophan; and
(b) tart cherry.

2. The composition of claim 1, wherein the leucine, isoleucine, valine, lysine, phenylalanine, threonine, histidine, methionine, and tryptophan are present in a total amount of about 5 g to about 20 g per serving of the composition.

3. The composition of claim 1, wherein the tart cherry is present in an amount of about 250 mg to about 1000 mg per serving of the composition.

4. The composition of claim 1, wherein the leucine is present in an amount of about 1 wt % to about 40 wt % per serving of the composition.

5. The composition of claim 1, wherein the isoleucine is present in an amount of about 0.5 wt % to about 20 wt % per serving of the composition.

6. The composition of claim 1, wherein the valine is present in an amount of about 1 wt % to about 20 wt % per serving of the composition.

7. The composition of claim 1, wherein the lysine is present in an amount of about 1 wt % to about 20 wt % per serving of the composition.

8. The composition of claim 1, wherein the phenylalanine is present in an amount of about 1 wt % to about 20 wt % per serving of the composition.

9. The composition of claim 1, wherein the threonine is present in an amount of about 0.5 wt % to about 15 wt % per serving of the composition.

10. The composition of claim 1, wherein the histidine is present in an amount of about 0.5 wt % to about 15 wt % per serving of the composition.

11. The composition of claim 1, wherein the methionine is present in an amount of about 0.03 wt % to about 5 wt % per serving of the composition.

12. The composition of claim 1, wherein the tryptophan is present in an amount of about 0.02 wt % to about 5 wt % per serving of the composition.

13. The composition of claim 1, wherein the composition further comprises creatine monohydrate.

14. The composition of claim 1, wherein the composition further comprises one or more minerals, one or more flavor enhancers, one or more vitamins, or any combination thereof.

15. The composition of claim 1, wherein the composition is in powdered form.

16. The composition of claim 1, wherein the composition is dissolved or suspended in liquid.

17. The composition of claim 1, wherein the composition is in powdered form and is dissolved or suspended in water.

18. A method of improving post-workout recovery, said method comprising administering an effective amount of the composition of claim 1 to a subject during or after exercise.

19. The method of claim 18, wherein the composition is administered less than 4 hours after exercise.

20. The method of claim 18, further comprising, prior to administering the composition, combining:
the composition comprising (a) leucine, isoleucine, valine, lysine, phenylalanine, threonine, histidine, methionine, and tryptophan, and (b) tart cherry, with
a volume of water.

21. The method of claim 20, wherein the volume of water is about 10 fluid ounces to about 20 fluid ounces.

22. A powdered dietary supplement composition contained in a bulk package, the bulk package containing a measuring scoop and the powdered dietary supplement composition, the measuring scoop being sized to scoop an amount of the powdered dietary supplement composition suitable for blending with a liquid to form a beverage, wherein the amount of the powdered dietary supplement composition is 15 g to 40 g and comprises:
(a) tart cherry in an amount of about 0.1 wt % to about 50 wt %;
(b) leucine in an amount of about 1 wt % to about 40 wt %;
(c) isoleucine in an amount of about 0.5 wt % to about 20 wt %;
(d) valine in an amount of about 1 wt % to about 20 wt %;
(e) lysine in an amount of about 1 wt % to about 20 wt %;
(f) phenylalanine in an amount of about 1 wt % to about 20 wt %;
(g) threonine in an amount of about 0.5 wt % to about 15 wt %;
(h) histidine in an amount of about 0.5 wt % to about 15 wt %;
(i) methionine in an amount of about 0.03 wt % to about 5 wt %; and
(j) tryptophan in an amount of about 0.02 wt % to about 5 wt %.

23. The powdered dietary supplement composition of claim 22, wherein the dietary supplement composition further comprises creatine monohydrate.

24. The powdered dietary supplement composition claim 22, wherein the dietary supplement composition further comprises one or more minerals.
